(19) United States
(12) Patent Application Publication
(10) Pub. No.: US 2026/0116236 A1
(43) Pub. Date: Apr. 30, 2026

(54) ELECTRIC CHARGING SYSTEM AND METHOD

(71) Applicant: GM Global Technology Operations LLC, Detroit, MI (US)

(72) Inventors: Akshay Sarin, Troy, MI (US); Alan B. Martin, Washington, MI (US)

(21) Appl. No.: 18/927,139

(22) Filed: Oct. 25, 2024

(51) Int. Cl. B60L 53/62; B60L 53/16

(52) U.S. Cl. CPC B60L 53/62; B60L 53/16

(57) ABSTRACT

A method for operating an electric charging station may include measuring an unloaded isolation resistance of the electric charging station with no load devices connected. The method further may include measuring a loaded isolation resistance of the electric charging station with two or more load devices connected to the electric charging station. The two or more load devices are in electrical communication with each other through the electric charging station. The method further may include changing an operation of the electric charging station based at least in part on at least one of: the unloaded isolation resistance and the loaded isolation resistance.

### INTRODUCTION

The present disclosure relates to systems and methods for charging electric devices such as, for example, electric vehicles.

Electric charging systems have been developed to charge portable devices powered by rechargeable energy storage systems (RESS). A prominent example of such systems is electric vehicle supply equipment (EVSE), which includes both alternating current (AC) EVSE and direct current (DC) EVSE for charging electric vehicles. AC EVSE allows for a direct connection to the grid, with the necessary AC-DC conversion handled by the vehicle itself. DC EVSE delivers direct current to the vehicle, eliminating the need for on-board conversion. Both AC and DC EVSE systems must maintain continuous isolation between low- and high-voltage buses as well as ground buses. Galvanic isolation may be used to maintain continuous isolation between the low- and high-voltage buses as well as ground buses. For example, transformers with galvanic isolation may be used to transfer energy within power converters of the EVSE to provide continuous isolation between low- and high-voltage buses as well as ground buses.

While current electric charging systems and methods achieve their intended purpose, there is a need for a new and improved system and method for charging electric devices and vehicles without galvanic isolation.

### SUMMARY

According to several aspects, a method for operating an electric charging station is provided. The method may include measuring an unloaded isolation resistance of the electric charging station with no load devices connected. The method further may include measuring a loaded isolation resistance of the electric charging station with two or more load devices connected to the electric charging station. The two or more load devices are in electrical communication with each other through the electric charging station. The method further may include changing an operation of the electric charging station based at least in part on at least one of: the unloaded isolation resistance and the loaded isolation resistance.

In another aspect of the present disclosure, measuring the unloaded isolation resistance further may include measuring the unloaded isolation resistance of the electric charging station. The electric charging station includes a power source and a plurality of non-isolated converters for connecting each of the two or more load devices to the power source. The unloaded isolation resistance includes an unloaded positive isolation resistance and an unloaded negative isolation resistance.

In another aspect of the present disclosure, measuring the loaded isolation resistance further may include measuring a first loaded isolation resistance with a first load device connected to a first non-isolating converter of the electric charging station. Measuring the loaded isolation resistance further may include measuring a second loaded isolation resistance with the first load device connected to the first non-isolating converter of the electric charging station and a second load device connected to a second non-isolating converter of the electric charging station.

In another aspect of the present disclosure, changing the operation of the electric charging station further may include determining a first load device isolation resistance based at least in part on the unloaded isolation resistance and the first loaded isolation resistance. Changing the operation of the electric charging station further may include determining a second load device isolation resistance based at least in part on the unloaded isolation resistance, the first loaded isolation resistance, and the second loaded isolation resistance. Changing the operation of the electric charging station further may include changing the operation of the electric charging station based at least in part on at least one of: the first load device isolation resistance and the second load device isolation resistance.

In another aspect of the present disclosure, measuring the loaded isolation resistance further may include measuring the first loaded isolation resistance with the first load device connected to the first non-isolating converter of the electric charging station. The first loaded isolation resistance includes a first loaded positive isolation resistance and a first loaded negative isolation resistance. Measuring the loaded isolation resistance further may include measuring the second loaded isolation resistance with the first load device connected to the first non-isolating converter of the electric charging station and the second load device connected to the second non-isolating converter of the electric charging station. The second loaded isolation resistance includes a second loaded positive isolation resistance and a second loaded negative isolation resistance.

In another aspect of the present disclosure, changing the operation of the electric charging station further may include determining a first load device isolation resistance based at least in part on the unloaded isolation resistance and the first loaded isolation resistance. The first load device isolation resistance includes a first load device positive isolation resistance and a first load device negative isolation resistance. Changing the operation of the electric charging station further may include determining a second load device isolation resistance based at least in part on the unloaded isolation resistance, the first loaded isolation resistance, and the second loaded isolation resistance. The second load device isolation resistance includes a second load device positive isolation resistance and a second load device negative isolation resistance. Changing the operation of the electric charging station further may include changing the operation of the electric charging station based at least in part on at least one of: the first load device positive isolation resistance, the first load device negative isolation resistance, the second load device positive isolation resistance, and the second load device negative isolation resistance.

In another aspect of the present disclosure, determining the first load device isolation resistance further may include determining the first load device positive isolation resistance using an equation:

$${R}_{I , L , 1}^{+} = {[ \frac{{V}_{S}}{{V}_{L , 1}} * [ \frac{1}{{R}_{I , S , 1}^{+}} - \frac{1}{{R}_{I , S , e ,}^{+}} ] ]}^{- 1}$$

where

$${R}_{I , L , 1}^{+}$$

R is the first load device positive isolation resistance, V_{S} is a high-voltage of the electric charging station, V_{L,1} is a voltage of the first load device,

$${R}_{I , S , 1}^{+}$$

is the first loaded positive isolation resistance, and

$${R}_{I , S , e ,}^{+}$$

is the unloaded positive isolation resistance. Determining the first load device isolation resistance further may include determining the first load device negative isolation resistance using an equation:

$${{R}_{I , L , 1}^{-} [ \frac{1}{{R}_{I , S , 1}^{-}} - \frac{1}{{R}_{I , S , e}^{-}} - [ 1 - \frac{{V}_{L , 1}}{{V}_{S}} * \frac{1}{{R}_{I , L , 1}^{+}} ] ]}^{- 1}$$

where

$${R}_{I , L , 1}^{-}$$

is the first load device negative isolation resistance,

$${R}_{I , S , 1}^{-}$$

is the first loaded negative isolation resistance,

$${R}_{I , S , e ,}^{-}$$

is the unloaded negative isolation resistance, V_{L,1} is the voltage of the first load device, V_{S} is the high-voltage of the electric charging station, and

$${R}_{I , L , 1}^{+}$$

is the first load device positive isolation resistance.

In another aspect of the present disclosure, determining the second load device isolation resistance further may include determining the second load device positive isolation resistance using an equation:

$${R}_{I , L , 2}^{+} = {[ \frac{{V}_{S}}{{V}_{L , 2}} * [ \frac{1}{{R}_{I , S , 2}^{+}} - \frac{1}{{R}_{I , S , 1 ,}^{+}} ] ]}^{- 1}$$

where

$${R}_{I , L , 2}^{+}$$

is the second load device positive isolation resistance, Vₛ is a high-voltage of the electric charging station, V_{L,2} is a voltage of the second load device,

$${R}_{I , S , 2}^{+}$$

is the second loaded positive isolation resistance, and

$${R}_{I , S , 1}^{+}$$

is the first loaded positive isolation resistance. Determining the second load device isolation resistance further may include determining the second load device negative isolation resistance using an equation:

$${R}_{I , L , 2}^{-} = {[ \frac{1}{{R}_{I , S , 2}^{-}} - \frac{1}{{R}_{I , S , e}^{-}} - [ 1 - \frac{{V}_{L , 2}}{{V}_{S}} * \frac{1}{{R}_{I , L , 2}^{+}} ] ]}^{- 1}$$

where

$${R}_{I , L , 2}^{-}$$

is the second load device negative isolation resistance,

$${R}_{I , S , 2}^{-}$$

is the second loaded negative isolation resistance,

$${R}_{I , S , e ,}^{-}$$

is the unloaded negative isolation resistance, V_{L,2} is the voltage of the second load device, Vₛ is the high-voltage of the electric charging station, and

$${R}_{I , L , 2}^{+}$$

is the second load device positive isolation resistance.

In another aspect of the present disclosure, changing the operation of the electric charging station further may include comparing the second loaded isolation resistance to a predetermined isolation resistance threshold. Changing the operation of the electric charging station further may include disconnecting one or more of the first load device and the second load device from the electric charging station in response to determining that the second loaded isolation resistance is less than the predetermined isolation resistance threshold based at least in part on at least one of: the first load device positive isolation resistance, the first load device negative isolation resistance, the second load device positive isolation resistance, and the second load device negative isolation resistance.

In another aspect of the present disclosure, disconnecting one or more of the first load device and the second load device further may include disconnecting the first load device in response to determining that the first load device positive isolation resistance is less than the second load device positive isolation resistance or that the first load device negative isolation resistance is less than the second load device negative isolation resistance. Disconnecting one or more of the first load device and the second load device further may include disconnecting the second load device in response to determining that the second load device positive isolation resistance is less than the first load device positive isolation resistance or that the second load device negative isolation resistance is less than the first load device negative isolation resistance.

According to several aspects, an electric charging station for charging a plurality of electric vehicles is provided. The electric charging station may include a power system may include a power source. The electric charging station further may include a plurality of non-isolating converters in electrical communication with the power source. The electric charging station further may include a plurality of charging handles, where each of the plurality of charging handles is in electrical communication with one of the plurality of non-isolating converters via one of a plurality of contactors, and where each of the plurality of charging handles is for connection to one of the plurality of electric vehicles. The electric charging station further may include a control system may include the plurality of contactors for controlling a connection between the plurality of non-isolating converters and the plurality of charging handles. The electric charging station further may include an insulation monitoring device (IMD) in electrical communication with the power system for monitoring an isolation resistance of the power system. The electric charging station further may include a controller in electrical communication with the plurality of contactors and the IMD. The controller is programmed to measure an unloaded isolation resistance of the electric charging station using the IMD with none of the plurality of electric vehicles connected. The unloaded isolation resistance includes an unloaded positive isolation resistance and an unloaded negative isolation resistance. The controller is further programmed to measure a loaded isolation resistance of the electric charging station with two or more of the plurality of electric vehicles connected to the electric charging station. The controller is further programmed to change an operation of one or more of the plurality of contactors based at least in part on at least one of: the unloaded isolation resistance and the loaded isolation resistance.

In another aspect of the present disclosure, to measure the loaded isolation resistance, the controller is further programmed to measure a first loaded isolation resistance with a first vehicle of the plurality of electric vehicles connected to a first non-isolating converter of the plurality of non-isolating converters. The first loaded isolation resistance includes a first loaded positive isolation resistance and a first loaded negative isolation resistance. To measure the loaded isolation resistance, the controller is further programmed to measure a second loaded isolation resistance with the first vehicle of the plurality of electric vehicles connected to the first non-isolating converter of the plurality of non-isolating converters and a second vehicle of the plurality of electric vehicles connected to a second non-isolating converter of the plurality of non-isolating converters. The second loaded isolation resistance includes a second loaded positive isolation resistance and a second loaded negative isolation resistance.

In another aspect of the present disclosure, to change the operation of one or more of the plurality of contactors, the controller is further programmed to determine a first vehicle isolation resistance of the first vehicle based at least in part on the unloaded isolation resistance and the first loaded isolation resistance. The first vehicle isolation resistance includes a first vehicle positive isolation resistance and a first vehicle negative isolation resistance. To change the operation of one or more of the plurality of contactors, the controller is further programmed to determine a second vehicle isolation resistance of the second vehicle based at least in part on the unloaded isolation resistance, the first loaded isolation resistance, and the second loaded isolation resistance. The second vehicle isolation resistance includes a second vehicle positive isolation resistance and a second vehicle negative isolation resistance. To change the operation of one or more of the plurality of contactors, the controller is further programmed to change the operation of one or more of the plurality of contactors based at least in part on at least one of: the first vehicle positive isolation resistance, the first vehicle negative isolation resistance, the second vehicle positive isolation resistance, and the second vehicle negative isolation resistance.

In another aspect of the present disclosure, to determine the first vehicle isolation resistance, the controller is further programmed to determine the first vehicle positive isolation resistance using an equation:

$${R}_{I , L , 1}^{+} = {[ \frac{{V}_{S}}{{V}_{L , 1}} * [ \frac{1}{{R}_{I , S , 1}^{+}} - \frac{1}{{R}_{I , S , e ,}^{+}} ] ]}^{- 1}$$

where

$${R}_{I , L , 1}^{+}$$

is the first load device positive isolation resistance, V_{S} is a high-voltage of the electric charging station, V_{L,1} is a voltage of the first load device,

$${R}_{I , S , 1}^{+}$$

is the first loaded positive isolation resistance, and

$${R}_{I , S , e ,}^{+}$$

is the unloaded positive isolation resistance. To determine the first vehicle isolation resistance, the controller is further programmed to determine the first vehicle negative isolation resistance using an equation:

$${{R}_{I , L , 1}^{-} [ \frac{1}{{R}_{I , S , 1}^{-}} - \frac{1}{{R}_{I , S , e}^{-}} - [ 1 - \frac{{V}_{L , 1}}{{V}_{S}} * \frac{1}{{R}_{I , L , 1}^{+}} ] ]}^{- 1}$$

where

$${R}_{I , L , 1}^{-}$$

is the first load device negative isolation resistance,

$${R}_{I , S , 1}^{-}$$

is the first loaded negative isolation resistance,

$${R}_{I , S , e ,}^{-}$$

is the unloaded negative isolation resistance, V_{L,1} is the voltage of the first load device, V_{S} is the high-voltage of the electric charging station, and

$${R}_{I , L , 1}^{+}$$

is the first load device positive isolation resistance.

In another aspect of the present disclosure, to determine the second vehicle isolation resistance, the controller is further programmed to determine the second vehicle positive isolation resistance using an equation:

$${R}_{I , L , 2}^{+} = {[ \frac{{V}_{S}}{{V}_{L , 2}} * [ \frac{1}{{R}_{I , S , 2}^{+}} - \frac{1}{{R}_{I , S , 1 ,}^{+}} ] ]}^{- 1}$$

where

$${R}_{I , L , 2}^{+}$$

is the second load device positive isolation resistance, Vₛ is a high-voltage of the electric charging station, V_{L,2} is a voltage of the second load device,

$${R}_{I , S , 2}^{+}$$

is the second loaded positive isolation resistance, and

$${R}_{I , S , 1}^{+}$$

is the first loaded positive isolation resistance. To determine the second vehicle isolation resistance, the controller is further programmed to determine the second vehicle negative isolation resistance using an equation:

$${R}_{I , L , 2}^{-} = {[ \frac{1}{{R}_{I , S , 2}^{-}} - \frac{1}{{R}_{I , S , e}^{-}} - [ 1 - \frac{{V}_{L , 2}}{{V}_{S}} * \frac{1}{{R}_{I , L , 2}^{+}} ] ]}^{- 1}$$

where

$${R}_{I , L , 2}^{-}$$

is the second load device negative isolation resistance,

$${R}_{I , S , 2}^{-}$$

is the second loaded negative isolation resistance,

$${R}_{I , S , e ,}^{-}$$

is the unloaded negative isolation resistance, V_{L,2} is the voltage of the second load device, Vₛ is the high-voltage of the electric charging station, and

$${R}_{I , L , 2}^{+}$$

is the second load device positive isolation resistance.

In another aspect of the present disclosure, to change the operation of one or more of the plurality of contactors, the controller is further programmed to compare the second loaded isolation resistance to a predetermined isolation resistance threshold. To change the operation of one or more of the plurality of contactors, the controller is further programmed to disconnect one or more of the first vehicle and the second vehicle from the electric charging station using one or more of the plurality of contactors in response to determining that the second loaded isolation resistance is less than the predetermined isolation resistance threshold.

In another aspect of the present disclosure, to disconnect one or more of the first vehicle and the second vehicle, the controller is further programmed to disconnect the first vehicle using one or more of the plurality of contactors in response to determining that the first vehicle positive isolation resistance is less than the second vehicle positive isolation resistance or that the first vehicle negative isolation resistance is less than the second vehicle negative isolation resistance. To disconnect one or more of the first vehicle and the second vehicle, the controller is further programmed to disconnect the second vehicle using one or more of the plurality of contactors in response to determining that the second vehicle positive isolation resistance is less than the first vehicle positive isolation resistance or that the second vehicle negative isolation resistance is less than the first vehicle negative isolation resistance.

According to several aspects, a method for operating an electric charging station for charging a plurality of electric vehicles is provided. The method may include measuring an unloaded isolation resistance of the electric charging station with none of the plurality of electric vehicles connected. The electric charging station includes a power source and a plurality of non-isolated converters for connecting each of the plurality of electric vehicles to the power source. The unloaded isolation resistance includes an unloaded positive isolation resistance and an unloaded negative isolation resistance. The method further may include measuring a loaded isolation resistance of the electric charging station with two or more of the plurality of electric vehicles connected to the electric charging station. The two or more of the plurality of electric vehicles are in electrical communication with each other through the electric charging station. The method further may include disconnecting one or more of the plurality of electric vehicles from the electric charging station based at least in part on at least one of: the unloaded isolation resistance and the loaded isolation resistance.

In another aspect of the present disclosure, measuring the loaded isolation resistance further may include measuring a first loaded isolation resistance with a first vehicle of the plurality of electric vehicles connected to a first non-isolating converter of the plurality of non-isolated converters. The first loaded isolation resistance includes a first loaded positive isolation resistance and a first loaded negative isolation resistance. Measuring the loaded isolation resistance further may include measuring a second loaded isolation resistance with the first vehicle connected to the first non-isolating converter of the electric charging station and a second vehicle of the plurality of electric vehicles connected to a second non-isolating converter of the plurality of non-isolated converters. The second loaded isolation resistance includes a second loaded positive isolation resistance and a second loaded negative isolation resistance.

In another aspect of the present disclosure, disconnecting one or more of the plurality of electric vehicles from the electric charging station further may include determining a first vehicle isolation resistance based at least in part on the unloaded isolation resistance and the first loaded isolation resistance. The first vehicle isolation resistance includes a first vehicle positive isolation resistance and a first vehicle negative isolation resistance. Disconnecting one or more of the plurality of electric vehicles from the electric charging station further may include determining a second vehicle isolation resistance based at least in part on the unloaded isolation resistance, the first loaded isolation resistance, and the second loaded isolation resistance. The second vehicle isolation resistance includes a second vehicle positive isolation resistance and a second vehicle negative isolation resistance. Disconnecting one or more of the plurality of electric vehicles from the electric charging station further may include disconnecting the first vehicle in response to determining that the first vehicle positive isolation resistance is less than the second vehicle positive isolation resistance or that the first vehicle negative isolation resistance is less than the second vehicle negative isolation resistance. Disconnecting one or more of the plurality of electric vehicles from the electric charging station further may include disconnecting the second vehicle in response to determining that the second vehicle positive isolation resistance is less than the first vehicle positive isolation resistance or that the second vehicle negative isolation resistance is less than the first vehicle negative isolation resistance.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The drawings described herein are for illustration purposes only and are not intended to limit the scope of the present disclosure in any way.

FIG. 1 is a schematic diagram of an electric charging station, according to an exemplary embodiment; and

FIG. 2 is a flowchart of a method for operating the electric charging station, according to an exemplary embodiment.

### DETAILED DESCRIPTION

The following description is merely exemplary in nature and is not intended to limit the present disclosure, application, or uses.

To ensure proper operation of electric charging systems, isolation between both low- and high-voltage buses and ground buses must be continuously monitored and maintained. Electric charging systems may be designed with galvanic isolation to ensure proper isolation. However, galvanic isolation may increase resource use, weight, and losses of electric charging systems. Therefore, the present disclosure provides a new and improved system and method for charging electronic devices, including, for example, electric vehicles, without galvanic isolation.

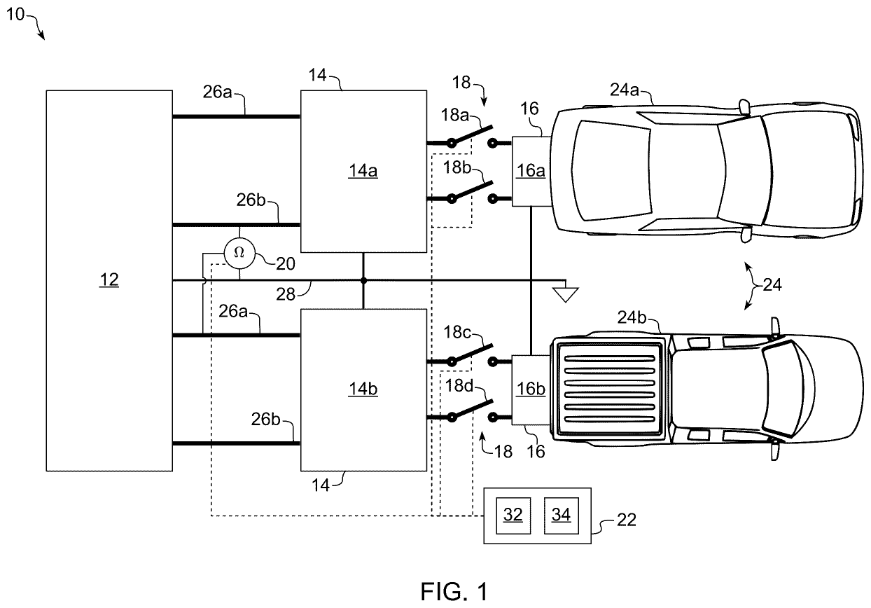

Referring to FIG. 1, an electric charging station is illustrated and generally indicated by reference number 10. The electric charging station 10 generally includes a power system and a control system. The power system generally includes a power source 12, a plurality of non-isolating converters 14, and a plurality of charging handles 16. The control system generally includes a plurality of contactors 18, an insulation monitoring device (IMD) 20, and a controller 22. The electric charging station 10 is used to charge a plurality of electric vehicles 24.

The power source 12 is a source of electrical power used to charge the plurality of electric vehicles 24. In a non-limiting example, the power source 12 includes a grid connection to an alternating current (AC) power grid, a rectifier, and one or more DC power converters and/or filters. In another non-limiting example, the power source 12 includes a generator (e.g., an internal combustion engine generator) for producing AC power, a rectifier, and one or more DC power converters and/or filters. In another non-limiting example, the power source 12 includes a renewable energy source (e.g., solar panels and/or wind turbines) for producing AC or DC power and one or more DC power converters and/or filters and/or rectifiers. In another non-limiting example, the power source 12 includes a fuel-cell energy source (e.g., a hydrogen fuel-cell) for producing DC power and one or more DC power converters and/or filters. In a non-limiting example, the power source 12 further includes a rechargeable energy storage system (RESS) (e.g., one or rechargeable batteries and associated circuitry) for buffering and storage of energy.

In an exemplary embodiment, the power source 12 is configured to provide high-voltage direct current (DC) power to the plurality of non-isolating converters 14. Accordingly, the power source 12 includes a positive high-voltage bus 26a and a negative high-voltage bus 26b connected to the plurality of non-isolating converters 14. Furthermore, the power source 12 is connected to a common ground bus 28 which provides a path for current flow in the event of a fault. In a non-limiting example, the common ground bus 28 is tied to the AC power grid and/or bonded to Earth. The common ground bus 28 is also connected to the plurality of non-isolating converters 14 and the plurality of charging handles 16, as will be discussed in greater detail below.

The plurality of non-isolating converters 14 are used to step-down the high-voltage provided by the power source 12 to appropriate voltages for charging the plurality of electric vehicles 24 and/or to regulate current flow from the power source 12 to/from the plurality of charging handles 16. In an exemplary embodiment, the plurality of non-isolating converters 14 includes one or more DC-DC buck converters, DC-DC buck-boost converters, and/or the like. A high-voltage side of each of the plurality of non-isolating converters 14 is connected to the positive high-voltage bus 26a and the negative high-voltage bus 26b of the power source 12. A low-voltage side of each of the plurality of non-isolating converters 14 is connected to the plurality of contactors 18.

In the scope of the present disclosure, “non-isolating” means a converter where the high-voltage side is not galvanically isolated from the low-voltage side. In other words, there is an electrical connection between components on the high-voltage side and the low-voltage side during normal operation of the converter. Utilizing non-isolating converters may provide advantages in electrical efficiency, resource use, and weight savings, for example. It should be understood that any non-galvanically-isolated uni- or bi-directional DC-DC or AC-DC converter capable of voltage and/or current regulation is within the scope of the present disclosure. In the exemplary embodiment shown in FIG. 1 and discussed below, the plurality of non-isolating converters 14 includes a first non-isolating converter 14a and a second non-isolating converter 14b. It should be understood that the plurality of non-isolating converters 14 may include any number of converters without departing from the scope of the present disclosure.

The plurality of charging handles 16 are used to connect the plurality of electric vehicles 24 to the electric charging station 10. In an exemplary embodiment, the plurality of charging handles 16 include electrical connectors for connecting the plurality of contactors 18 and the common ground bus 28 to the plurality of electric vehicles 24. In a non-limiting example, the plurality of charging handles 16 include additional electrical connectors for communication between the plurality of electric vehicles 24 and the electric charging station 10 (e.g., a control status connector, a control pilot connector, and/or the like). In a non-limiting example, the plurality of charging handles 16 are realized according to specifications such as SAE J1772, SAE J3400, and/or the like. It should be understood that any electrical connector suitable for transfer of energy for charging a load device such as the plurality of electric vehicles 24 is within the scope of the present disclosure.

In the exemplary embodiment shown in FIG. 1 and discussed below, the plurality of charging handles 16 includes a first charging handle 16a for connection to a first vehicle 24a of the plurality of electric vehicles 24 and a second charging handle 16b for connection to a second vehicle 24b of the plurality of electric vehicles 24. In a non-limiting example, when the first charging handle 16a is plugged into the first vehicle 24a, the low-voltage side of the first non-isolating converter 14a is connected to a traction battery (not shown) of the first vehicle 24a via two of the plurality of contactors 18 and the common ground bus 28 is connected to a chassis ground of the first vehicle 24a.

When the second charging handle 16b is plugged into the second vehicle 24b, the low-voltage side of the second non-isolating converter 14b is connected to a traction battery (not shown) of the second vehicle 24b via two of the plurality of contactors 18 and the common ground bus 28 is connected to a chassis ground of the second vehicle 24b. It should be understood that the power system may include any number of charging handles 16 for connection to any number of vehicles without departing from the scope of the present disclosure.

The plurality of contactors 18 are used to connect/disconnect the plurality of non-isolating converters 14 from the plurality of charging handles 16 (and thus the plurality of electric vehicles 24 and/or any other connected load device). In an exemplary embodiment, each of the plurality of contactors 18 is an electromechanical device designed to make or break electrical connections in circuits carrying high voltages and/or currents. In a non-limiting example, each of the plurality of contactors 18 includes a set of contacts (not shown), an electromagnet (not shown), and a control circuit (not shown). The set of contacts includes movable and stationary contact points which can be brought together or separated by the electromagnet. The electromagnet generates a magnetic field when energized by the control circuit. The magnetic field attracts or repels the movable contact points, thereby actuating each of the plurality of contactors 18.

In operation, when the controller 22 sends a signal to the control circuit, the control circuit energizes the electromagnet and the contacts are closed, allowing electrical current to flow between the plurality of non-isolating converters 14 and the plurality of charging handles 16. Conversely, when the control circuit de-energizes the electromagnet, the contacts are opened, interrupting the flow of current between the plurality of non-isolating converters 14 and the plurality of charging handles 16.

In the exemplary embodiment shown in FIG. 1 and discussed below, the plurality of contactors 18 includes a first contactor 18a, a second contactor 18b, a third contactor 18c, and a fourth contactor 18d. It should be understood that the plurality of contactors 18 may be realized using any electronically controllable switch, including relays, solid-state electronic switches (e.g., transistors), and/or the like without departing from the scope of the present disclosure. The plurality of contactors 18 are in electrical communication with the controller 22, as will be discussed in greater detail below.

The IMD 20 is used to determine a positive isolation resistance between the positive high-voltage bus 26a and the common ground bus 28 and a negative isolation resistance between the negative high-voltage bus 26b and the common ground bus 28. In an exemplary embodiment, the IMD 20 includes a measurement unit (not shown) and an IMD controller (not shown) in electrical communication with the measurement unit. In a non-limiting example, the measurement unit applies a small voltage between the positive high-voltage bus 26a and the common ground bus 28, and between the negative high-voltage bus 26b and the common ground bus 28 and detects the resulting current flows. The IMD controller calculates the positive isolation resistance and the negative isolation resistance based on the current detected by the measurement unit.

In the exemplary embodiment shown in FIG. 1 and discussed herein, the IMD 20 is shown as connected between the positive high-voltage bus 26a, the common ground bus 28, and the negative high-voltage bus 26b. It should be understood that because the plurality of non-isolating converters 14 do not provide galvanic isolation between the high-voltage side and the low-voltage side, the IMD 20 may be connected anywhere in the electric charging station 10 between a positive bus, a negative bus, and the common ground bus 28, including, for example, within the power source 12, proximal to the plurality of contactors 18, and/or within the plurality of charging handles 16. It should further be understood that the control system may include any number of IMDs without departing from the scope of the present disclosure. The IMD 20 is in electrical communication with the controller 22, as will be discussed in greater detail below.

The controller 22 is used to implement a method 100 for operating an electric charging station, as will be described below. The controller 22 includes at least one processor 32 and a non-transitory computer readable storage device or media 34. The processor 32 may be a custom made or commercially available processor, a central processing unit (CPU), a graphics processing unit (GPU), an auxiliary processor among several processors associated with the controller 22, a semiconductor-based microprocessor (in the form of a microchip or chip set), a macroprocessor, a combination thereof, or generally a device for executing instructions.

The computer readable storage device or media 34 may include volatile and nonvolatile storage in read-only memory (ROM), random-access memory (RAM), and keep-alive memory (KAM), for example. KAM is a persistent or non-volatile memory that may be used to store various operating variables while the processor 32 is powered down. The computer-readable storage device or media 34 may be implemented using a number of memory devices such as PROMs (programmable read-only memory), EPROMs (electrically PROM), EEPROMs (electrically erasable PROM), flash memory, or another electric, magnetic, optical, or combination memory devices capable of storing data, some of which represent executable instructions, used by the controller 22 to perform the method 100. The controller 22 may also consist of multiple controllers which are in electrical communication with each other.

The controller 22 is in electrical communication with the plurality of contactors 18 and the IMD 20. In an exemplary embodiment, the electrical communication is established using, for example, a CAN network, a FLEXRAY network, a local area network (e.g., WiFi, ethernet, and the like), a serial peripheral interface (SPI) network, or the like. It should be understood that various additional wired and wireless techniques and communication protocols for communicating with the controller 22 are within the scope of the present disclosure. It should further be understood that, in the scope of the present disclosure, electrical communication also includes power and/or energy transfer between electrical devices (e.g., using conducting wires and/or wireless power transmission techniques).

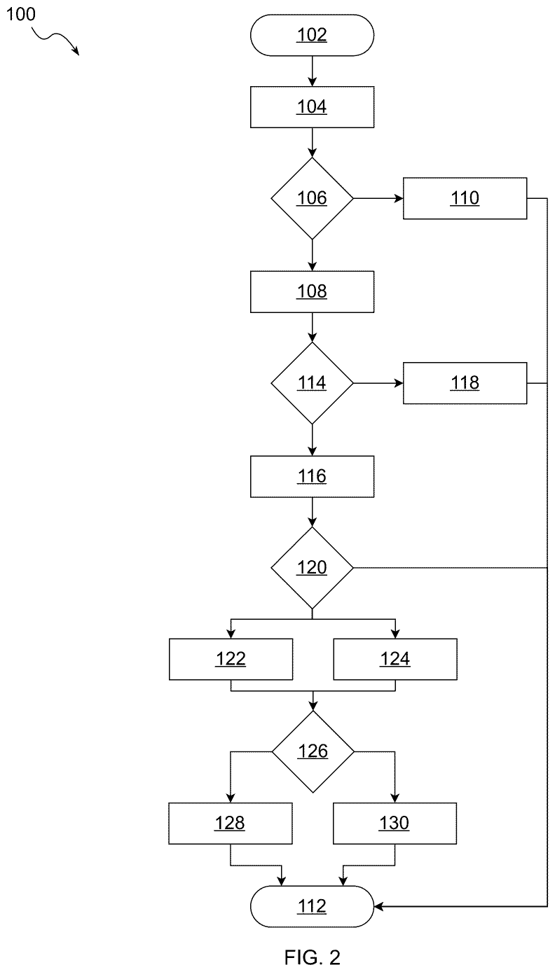

Referring to FIG. 2, a flowchart of the method 100 for operating the electric charging station 10 is shown. The method 100 begins at block 102 and proceeds to block 104. At block 104, the controller 22 uses the IMD 20 to measure an unloaded isolation resistance of the electric charging station 10 with no load devices connected. In an exemplary embodiment, the unloaded isolation resistance is measured when each of the plurality of contactors 18 are closed, but none of the plurality of electric vehicles 24 or other load devices are connected to the plurality of charging handles 16. The unloaded isolation resistance includes both an unloaded positive isolation resistance (e.g., measured between the positive high-voltage bus 26a and the common ground bus 28) and an unloaded negative isolation resistance (e.g., measured between the negative high-voltage bus 26b and the common ground bus 28). The unloaded isolation resistance is stored in the media 34 for future retrieval. After block 104, the method 100 proceeds to block 106.

At block 106, the controller 22 compares the unloaded isolation resistance determined at block 104 to a predetermined isolation resistance threshold (e.g., 500 Ω/V). If the unloaded positive isolation resistance and/or the unloaded negative isolation resistance is greater than or equal to the predetermined isolation resistance threshold, the method 100 proceeds to block 108, as will be discussed in greater detail below. If the unloaded positive isolation resistance and/or the unloaded negative isolation resistance is less than the predetermined isolation resistance threshold, the method 100 proceeds to block 110.

At block 110, the controller 22 disables the electric charging station 10 in response to determining that the unloaded positive isolation resistance and/or the unloaded negative isolation resistance is less than the predetermined isolation resistance threshold. In an exemplary embodiment, to disable the electric charging station 10, the controller 22 opens each of the plurality of contactors 18. In a non-limiting example, the plurality of charging handles 16 are also configured to provide a signal to any connected load devices (e.g., the plurality of electric vehicles 24) that charging is unavailable. After block 110, the method 100 proceeds to enter a standby state at block 112.

At block 108, the controller 22 uses the IMD 20 to measure a first loaded isolation resistance with a first load device connected to the first non-isolating converter 14a. In an exemplary embodiment, the first load device is the first vehicle 24a. In a non-limiting example, the first loaded isolation resistance is measured with each of the plurality of contactors 18 closed, the first vehicle 24a connected to the first charging handle 16a, and no vehicle or load connected to the second charging handle 16b. The first loaded isolation resistance includes a first loaded positive isolation resistance (e.g., measured between the positive high-voltage bus 26a and the common ground bus 28) and a first loaded negative isolation resistance (e.g., measured between the negative high-voltage bus 26b and the common ground bus 28). The first loaded isolation resistance is stored in the media 34 for future retrieval. After block 108, the method 100 proceeds to block 114.

At block 114, the controller 22 compares the first loaded isolation resistance determined at block 108 to the predetermined isolation resistance threshold (e.g., 500 Ω/V). If the first loaded positive isolation resistance and/or the first loaded negative isolation resistance is greater than or equal to the predetermined isolation resistance threshold, the method 100 proceeds to block 116, as will be discussed in greater detail below. If the first loaded positive isolation resistance and/or the first loaded negative isolation resistance is less than the predetermined isolation resistance threshold, the method 100 proceeds to block 118.

At block 118, the controller 22 disconnects the first load device (e.g., the first vehicle 24a) in response to determining that the first loaded positive isolation resistance and/or the first loaded negative isolation resistance is less than the predetermined isolation resistance threshold. In an exemplary embodiment, to disconnect the first load device (e.g., the first vehicle 24a), the controller 22 opens the first contactor 18a and the second contactor 18b. In a non-limiting example, the first charging handle 16a is also configured to provide a signal to the first load device (e.g., the first vehicle 24a) that charging is unavailable. After block 118, the method 100 proceeds to enter the standby state at block 112.

At block 116, the controller 22 uses the IMD 20 to measure a second loaded isolation resistance with the first load device connected to the first non-isolating converter 14a and a second load device connected to the second non-isolating converter 14b. In an exemplary embodiment, the first load device is the first vehicle 24a and the second load device is the second vehicle 24b. In a non-limiting example, the second loaded isolation resistance is measured with each of the plurality of contactors 18 closed, the first vehicle 24a connected to the first charging handle 16a and the second vehicle 24b connected to the second charging handle 16b. The second loaded isolation resistance includes a second loaded positive isolation resistance (e.g., measured between the positive high-voltage bus 26a and the common ground bus 28) and a second loaded negative isolation resistance (e.g., measured between the negative high-voltage bus 26b and the common ground bus 28). The second loaded isolation resistance is stored in the media 34 for future retrieval. After block 116, the method 100 proceeds to block 120.

At block 120, the controller 22 compares the second loaded isolation resistance determined at block 116 to the predetermined isolation resistance threshold (e.g., 500 Ω/V). If the second loaded positive isolation resistance and/or the second loaded negative isolation resistance is greater than or equal to the predetermined isolation resistance threshold, the method 100 proceeds to enter the standby state at block 112. If the second loaded positive isolation resistance and/or the second loaded negative isolation resistance is less than the predetermined isolation resistance threshold, the method 100 proceeds to blocks 122 and 124.

At block 122, the controller 22 determines a first load device isolation resistance. In the scope of the present disclosure, the first load device isolation resistance is an isolation resistance of the circuitry of the first load device itself. The first load device isolation resistance includes a first load device positive isolation resistance (e.g., measured between a positive voltage bus of the first load device and a chassis ground of the first load device) and a first load device negative isolation resistance (e.g., measured between a negative voltage bus of the first load device and a chassis ground of the first load device). In a non-limiting example, the first load device is the first vehicle 24a. In an exemplary embodiment, the first load device isolation resistance is determined based at least in part on the unloaded isolation resistance determined at block 104 and the first loaded isolation resistance determined at block 108. In a non-limiting example, the first load device positive isolation resistance is determined using an equation:

$${R}_{I , L , 1}^{+} = {[ \frac{{V}_{S}}{{V}_{L , 1}} * [ \frac{1}{{R}_{I , S , 1}^{+}} - \frac{1}{{R}_{I , S , e ,}^{+}} ] ]}^{- 1} \qquad ( 1 )$$

where

$${R}_{I , L , 1}^{+}$$

is the first load device positive isolation resistance, V_{S} is a high-voltage of the electric charging station 10, V_{L,1} is a voltage of the first load device (e.g., a traction battery voltage of the first vehicle 24a),

$${R}_{I , S , 1}^{+}$$

is the first loaded positive isolation resistance determined at block 108, and

$${R}_{I , S , e ,}^{+}$$

is the unloaded positive isolation resistance determined at block 104.

In a non-limiting example, the first load device negative isolation resistance is determined using an equation:

$${{R}_{I , L , 1}^{-} [ \frac{1}{{R}_{I , S , 1}^{-}} - \frac{1}{{R}_{I , S , e}^{-}} - [ 1 - \frac{{V}_{L , 1}}{{V}_{S}} * \frac{1}{{R}_{I , L , 1}^{+}} ] ]}^{- 1} \qquad ( 2 )$$

where

$${R}_{I , L , 1}^{-}$$

is the first load device negative isolation resistance,

$${R}_{I , S , 1}^{-}$$

is the first loaded negative isolation resistance determined at block 108,

$${R}_{I , S , e ,}^{-}$$

is the unloaded negative isolation resistance determined at block 104, V_{L,1} is the voltage of the first load device (e.g., a traction battery voltage of the first vehicle 24a), V_{S} is the high-voltage of the electric charging station 10, and

$${R}_{I , L , 1}^{+}$$

is the first load device positive isolation resistance (e.g., determined using Equation 1).

In an exemplary embodiment, if the first load device isolation resistance is less than a predetermined load device resistance threshold, the first contactor 18a and the second contactor 18b are opened. In another exemplary embodiment, the first load device isolation resistance is transmitted to a controller of the first load device (e.g., a vehicle controller of the first vehicle 24a) for diagnostic purposes. After block 122, the method 100 proceeds to block 126, as will be discussed in greater detail below.

At block 124, the controller 22 determines a second load device isolation resistance. In the scope of the present disclosure, the second load device isolation resistance is an isolation resistance of the circuitry of the second load device itself. The second load device isolation resistance includes a second load device positive isolation resistance (e.g., measured between a positive voltage bus of the second load device and a chassis ground of the second load device) and a second load device negative isolation resistance (e.g., measured between a negative voltage bus of the second load device and a chassis ground of the second load device). In a non-limiting example, the second load device is the second vehicle 24b. In an exemplary embodiment, the second load device isolation resistance is determined based at least in part on the unloaded isolation resistance determined at block 104, the first loaded isolation resistance determined at block 108, and the second loaded isolation resistance determined at block 116. In a non-limiting example, the second load device positive isolation resistance is determined using an equation:

$${R}_{I , L , 2}^{+} = {[ \frac{{V}_{S}}{{V}_{L , 2}} * [ \frac{1}{{R}_{I , S , 2}^{+}} - \frac{1}{{R}_{I , S , 1 ,}^{+}} ] ]}^{- 1} \qquad ( 3 )$$

where

$${R}_{I , L , 2}^{+}$$

is the second load device positive isolation resistance, Vₛ is the high-voltage of the electric charging station 10, V_{L,2} is a voltage of the second load device (e.g., a traction battery voltage of the second vehicle 24b),

$${R}_{I , S , 2}^{+}$$

is the second loaded positive isolation resistance determined at block 116, and

$${R}_{I , S , 1}^{+}$$

is the first loaded positive isolation resistance determined at block 108.

In a non-limiting example, the second load device negative isolation resistance is determined using an equation:

$${R}_{I , L , 2}^{-} = {[ \frac{1}{{R}_{I , S , 2}^{-}} - \frac{1}{{R}_{I , S , e}^{-}} - [ 1 - \frac{{V}_{L , 2}}{{V}_{S}} * \frac{1}{{R}_{I , L , 2}^{+}} ] ]}^{- 1} \qquad ( 4 )$$

where

$${R}_{I , L , 2}^{-}$$

is the second load device negative isolation resistance,

$${R}_{I , S , 2}^{-}$$

is the second loaded negative isolation resistance determined at block 116,

$${R}_{I , S , e ,}^{-}$$

is the unloaded negative isolation resistance determined at block 104, V_{L,2} is the voltage of the second load device (e.g., a traction battery voltage of the second vehicle 24b), Vₛ is the high-voltage of the electric charging station 10, and

$${R}_{I , L , 2}^{+}$$

is the second load device positive isolation resistance (e.g., determined using Equation 3).

In an exemplary embodiment, if the second load device isolation resistance is less than a predetermined load device resistance threshold, the third contactor 18c and the fourth contactor 18d are opened. In another exemplary embodiment, the second load device isolation resistance is transmitted to a controller of the second load device (e.g., a vehicle controller of the second vehicle 24b) for diagnostic purposes. After block 124, the method 100 proceeds to block 126.

At block 126, the controller 22 compares the first load device isolation resistance determined at block 122 to the second load device isolation resistance determined at block 124. If the first load device positive isolation resistance or the first load device negative isolation resistance is less than the second load device positive isolation resistance or the second load device negative isolation resistance, the method 100 proceeds to block 128, as will be discussed in greater detail below. If the second load device positive isolation resistance or the second load device negative isolation resistance is less than the first load device positive isolation resistance or the first load device negative isolation resistance, the method 100 proceeds to block 130.

At block 130, the controller 22 disconnects the second load device (e.g., the second vehicle 24b) in response to determining that the second loaded isolation resistance is less than the predetermined isolation resistance threshold and that the second load device positive isolation resistance or the second load device negative isolation resistance is less than the first load device positive isolation resistance or the first load device negative isolation resistance. In an exemplary embodiment, to disconnect the second load device (e.g., the second vehicle 24b), the controller 22 opens the third contactor 18c and the fourth contactor 18d. In a non-limiting example, second charging handle 16b is also configured to provide a signal to the second load device (e.g., the second vehicle 24b) that charging is unavailable. By disconnecting the load device having the lowest isolation resistance, the overall isolation resistance of the electric charging station 10 is increased, allowing for continued operation of the electric charging station 10 and supply of other load devices (e.g., the first vehicle 24a).

In an exemplary embodiment, after disconnecting the second load device, the second loaded isolation resistance is re-measured and compared to the predetermined isolation resistance threshold. If the second loaded isolation resistance is still less than the predetermined isolation resistance threshold, the controller 22 also disconnects the first load device, as will be discussed below. After block 130, the method 100 proceeds to enter the standby state at block 112.

At block 128, the controller 22 disconnects the first load device (e.g., the first vehicle 24a) in response to determining that the second loaded isolation resistance is less than the predetermined isolation resistance threshold and that the first load device positive isolation resistance or the first load device negative isolation resistance is less than the second load device positive isolation resistance or the second load device negative isolation resistance. In an exemplary embodiment, to disconnect the first load device (e.g., the first vehicle 24a), the controller 22 opens the first contactor 18a and the second contactor 18b. In a non-limiting example, the first charging handle 16a is also configured to provide a signal to the first load device (e.g., the first vehicle 24a) that charging is unavailable. By disconnecting the load device having the lowest isolation resistance, the overall isolation resistance of the electric charging station 10 is increased, allowing for continued operation of the electric charging station 10 and supply of other load devices (e.g., the second vehicle 24b).

In an exemplary embodiment, after disconnecting the first load device, the second loaded isolation resistance is re-measured and compared to the predetermined isolation resistance threshold. If the second loaded isolation resistance is still less than the predetermined isolation resistance threshold, the controller 22 also disconnects the second load device, as discussed above. After block 128, the method 100 proceeds to enter the standby state at block 112.

In an exemplary embodiment, the controller 22 repeatedly exits the standby state 112 and restarts the method 100 at block 102. In a non-limiting example, the controller 22 exits the standby state 112 and restarts the method 100 on a timer, for example, every three hundred milliseconds.

While the method 100 is described for an exemplary embodiment including two vehicles, it should be understood that the electric charging station 10 and method 100 are applicable to any electric charging system, including, for example, electric utility vehicle charging systems, electric consumer device (e.g., tools, portable computers, smartphones, household devices) charging systems, and/or the like. Furthermore, the electric charging station 10 and method 100 are applicable to any number of load devices (e.g., more than two vehicles or other load devices).

The electric charging station 10 and the method 100 of the present disclosure offer several advantages. The electric charging station 10 of the present disclosure offers, for example, increased efficiency, decreased resource use, decreased size, and decreased weight when compared to conventional charging systems due to the use of non-isolated converters. Using the method 100 of the present disclosure, isolation faults in the electric charging station 10 or connected load devices are identified, localized, and isolated to minimize disruption to other components of the electric charging station 10 and/or connected load devices. Using the method 100, the electric charging station 10 may remain at least partially operational even if a fault condition is detected.

The description of the present disclosure is merely exemplary in nature and variations that do not depart from the gist of the present disclosure are intended to be within the scope of the present disclosure. Such variations are not to be regarded as a departure from the spirit and scope of the present disclosure.

What is claimed is:

1. A method for operating an electric charging station, the method comprising:
measuring an unloaded isolation resistance of the electric charging station with no load devices connected;
measuring a loaded isolation resistance of the electric charging station with two or more load devices connected to the electric charging station, wherein the two or more load devices are in electrical communication with each other through the electric charging station; and
changing an operation of the electric charging station based at least in part on at least one of: the unloaded isolation resistance and the loaded isolation resistance.

2. The method of claim 1, wherein measuring the unloaded isolation resistance further comprises:
measuring the unloaded isolation resistance of the electric charging station, wherein the electric charging station includes a power source and a plurality of non-isolated converters for connecting each of the two or more load devices to the power source, and wherein the unloaded isolation resistance includes an unloaded positive isolation resistance and an unloaded negative isolation resistance.

3. The method of claim 2, wherein measuring the loaded isolation resistance further comprises:
measuring a first loaded isolation resistance with a first load device connected to a first non-isolating converter of the electric charging station; and
measuring a second loaded isolation resistance with the first load device connected to the first non-isolating converter of the electric charging station and a second load device connected to a second non-isolating converter of the electric charging station.

4. The method of claim 3, wherein changing the operation of the electric charging station further comprises:
determining a first load device isolation resistance based at least in part on the unloaded isolation resistance and the first loaded isolation resistance;
determining a second load device isolation resistance based at least in part on the unloaded isolation resistance, the first loaded isolation resistance, and the second loaded isolation resistance; and
changing the operation of the electric charging station based at least in part on at least one of: the first load device isolation resistance and the second load device isolation resistance.

5. The method of claim 3, wherein measuring the loaded isolation resistance further comprises:
measuring the first loaded isolation resistance with the first load device connected to the first non-isolating converter of the electric charging station, wherein the first loaded isolation resistance includes a first loaded positive isolation resistance and a first loaded negative isolation resistance; and
measuring the second loaded isolation resistance with the first load device connected to the first non-isolating converter of the electric charging station and the second load device connected to the second non-isolating converter of the electric charging station, wherein the second loaded isolation resistance includes a second loaded positive isolation resistance and a second loaded negative isolation resistance.

6. The method of claim 5, wherein changing the operation of the electric charging station further comprises:
determining a first load device isolation resistance based at least in part on the unloaded isolation resistance and the first loaded isolation resistance, wherein the first load device isolation resistance includes a first load device positive isolation resistance and a first load device negative isolation resistance;
determining a second load device isolation resistance based at least in part on the unloaded isolation resistance, the first loaded isolation resistance, and the second loaded isolation resistance, wherein the second load device isolation resistance includes a second load device positive isolation resistance and a second load device negative isolation resistance; and
changing the operation of the electric charging station based at least in part on at least one of: the first load device positive isolation resistance, the first load device negative isolation resistance, the second load device positive isolation resistance, and the second load device negative isolation resistance.

7. The method of claim 6, wherein determining the first load device isolation resistance further comprises:
determining the first load device positive isolation resistance using an equation:
$${R}_{I , L , 1}^{+} = {[ \frac{{V}_{S}}{{V}_{L , 1}} * [ \frac{1}{{R}_{I , S , 1}^{+}} - \frac{1}{{R}_{I , S , e ,}^{+}} ] ]}^{- 1}$$
wherein
$${R}_{I , L , 1}^{+}$$
is the first load device positive isolation resistance, V_{S} is a high-voltage of the electric charging station, V_{L,1} is a voltage of the first load device,
$${R}_{I , S , 1}^{+}$$
is the first loaded positive isolation resistance, and
$${R}_{I , S , e ,}^{+}$$
is the unloaded positive isolation resistance; and
determining the first load device negative isolation resistance using an equation:
$${{R}_{I , L , 1}^{-} [ \frac{1}{{R}_{I , S , 1}^{-}} - \frac{1}{{R}_{I , S , e}^{-}} - [ 1 - \frac{{V}_{L , 1}}{{V}_{S}} * \frac{1}{{R}_{I , L , 1}^{+}} ] ]}^{- 1}$$
wherein
$${R}_{I , L , 1}^{-}$$
is the first load device negative isolation resistance,
$${R}_{I , S , 1}^{-}$$
is the first loaded negative isolation resistance,
$${R}_{I , S , e ,}^{-}$$
is the unloaded negative isolation resistance, V_{L,1} is the voltage of the first load device, V_{S} is the high-voltage of the electric charging station, and
$${R}_{I , L , 1}^{+}$$
is the first load device positive isolation resistance.

8. The method of claim 6, wherein determining the second load device isolation resistance further comprises:
determining the second load device positive isolation resistance using an equation:
$${R}_{I , L , 2}^{+} = {[ \frac{{V}_{S}}{{V}_{L , 2}} * [ \frac{1}{{R}_{I , S , 2}^{+}} - \frac{1}{{R}_{I , S , 1 ,}^{+}} ] ]}^{- 1}$$
wherein
$${R}_{I , L , 2}^{+}$$
is the second load device positive isolation resistance, Vₛ is a high-voltage of the electric charging station, V_{L,2} is a voltage of the second load device,
$${R}_{I , S , 2}^{+}$$
is the second loaded positive isolation resistance, and
$${R}_{I , S , 1}^{+}$$
is the first loaded positive isolation resistance; and
determining the second load device negative isolation resistance using an equation:
$${R}_{I , L , 2}^{-} = {[ \frac{1}{{R}_{I , S , 2}^{-}} - \frac{1}{{R}_{I , S , e}^{-}} - [ 1 - \frac{{V}_{L , 2}}{{V}_{S}} * \frac{1}{{R}_{1 , L , 2}^{+}} ] ]}^{- 1}$$
wherein
$${R}_{I , L , 2}^{-}$$
is the second load device negative isolation resistance,
$${R}_{I , S , 2}^{-}$$
is the second loaded negative isolation resistance,
$${R}_{I , S , e ,}^{-}$$
is the unloaded negative isolation resistance, V_{L,2} is the voltage of the second load device, Vₛ is the high-voltage of the electric charging station, and
$${R}_{I , L , 2}^{+}$$
is the second load device positive isolation resistance.

9. The method of claim 6, wherein changing the operation of the electric charging station further comprises:
comparing the second loaded isolation resistance to a predetermined isolation resistance threshold; and
disconnecting one or more of the first load device and the second load device from the electric charging station in response to determining that the second loaded isolation resistance is less than the predetermined isolation resistance threshold based at least in part on at least one of: the first load device positive isolation resistance, the first load device negative isolation resistance, the second load device positive isolation resistance, and the second load device negative isolation resistance.

10. The method of claim 9, wherein disconnecting one or more of the first load device and the second load device further comprises:
disconnecting the first load device in response to determining that the first load device positive isolation resistance is less than the second load device positive isolation resistance or that the first load device negative isolation resistance is less than the second load device negative isolation resistance; and
disconnecting the second load device in response to determining that the second load device positive isolation resistance is less than the first load device positive isolation resistance or that the second load device negative isolation resistance is less than the first load device negative isolation resistance.

11. An electric charging station for charging a plurality of electric vehicles, the electric charging station comprising:
a power system comprising:
a power source;
a plurality of non-isolating converters in electrical communication with the power source;
a plurality of charging handles, wherein each of the plurality of charging handles is in electrical communication with one of the plurality of non-isolating converters via one of a plurality of contactors, and wherein each of the plurality of charging handles is for connection to one of the plurality of electric vehicles; and
a control system comprising:
the plurality of contactors for controlling a connection between the plurality of non-isolating converters and the plurality of charging handles;
an insulation monitoring device (IMD) in electrical communication with the power system for monitoring an isolation resistance of the power system; and
a controller in electrical communication with the plurality of contactors and the IMD, wherein the controller is programmed to:
measure an unloaded isolation resistance of the electric charging station using the IMD with none of the plurality of electric vehicles connected, wherein the unloaded isolation resistance includes an unloaded positive isolation resistance and an unloaded negative isolation resistance;
measure a loaded isolation resistance of the electric charging station with two or more of the plurality of electric vehicles connected to the electric charging station; and
change an operation of one or more of the plurality of contactors based at least in part on at least one of: the unloaded isolation resistance and the loaded isolation resistance.

12. The electric charging station of claim 11, wherein to measure the loaded isolation resistance, the controller is further programmed to:
measure a first loaded isolation resistance with a first vehicle of the plurality of electric vehicles connected to a first non-isolating converter of the plurality of non-isolating converters, wherein the first loaded isolation resistance includes a first loaded positive isolation resistance and a first loaded negative isolation resistance; and
measure a second loaded isolation resistance with the first vehicle of the plurality of electric vehicles connected to the first non-isolating converter of the plurality of non-isolating converters and a second vehicle of the plurality of electric vehicles connected to a second non-isolating converter of the plurality of non-isolating converters, wherein the second loaded isolation resistance includes a second loaded positive isolation resistance and a second loaded negative isolation resistance.

13. The electric charging station of claim 12, wherein to change the operation of one or more of the plurality of contactors, the controller is further programmed to:
determine a first vehicle isolation resistance of the first vehicle based at least in part on the unloaded isolation resistance and the first loaded isolation resistance, wherein the first vehicle isolation resistance includes a first vehicle positive isolation resistance and a first vehicle negative isolation resistance;
determine a second vehicle isolation resistance of the second vehicle based at least in part on the unloaded isolation resistance, the first loaded isolation resistance, and the second loaded isolation resistance, wherein the second vehicle isolation resistance includes a second vehicle positive isolation resistance and a second vehicle negative isolation resistance; and
change the operation of one or more of the plurality of contactors based at least in part on at least one of: the first vehicle positive isolation resistance, the first vehicle negative isolation resistance, the second vehicle positive isolation resistance, and the second vehicle negative isolation resistance.

14. The electric charging station of claim 13, to determine the first vehicle isolation resistance, the controller is further programmed to:
determine the first vehicle positive isolation resistance using an equation:
$${R}_{I , L , 1}^{+} = {[ \frac{{V}_{S}}{{V}_{L , 1}} * [ \frac{1}{{R}_{I , S , 1}^{+}} - \frac{1}{{R}_{I , S , e ,}^{+}} ] ]}^{- 1}$$
wherein
$${R}_{I , L , 1}^{+}$$
is the first vehicle positive isolation resistance, V_{S} is a high-voltage of the electric charging station, V_{L,1} is a voltage of the first vehicle,
$${R}_{I , S , 1}^{+}$$
is the first loaded positive isolation resistance, and
$${R}_{I , S , e ,}^{+}$$
is the unloaded positive isolation resistance; and
determine the first vehicle negative isolation resistance using an equation:
$${R}_{I , L , 1}^{-} = {[ \frac{1}{{R}_{I , S , 1}^{-}} - \frac{1}{{R}_{I , S , e}^{-}} - [ 1 - \frac{{V}_{L , 1}}{{V}_{S}} * \frac{1}{{R}_{I , L , 1}^{+}} ] ]}^{- 1}$$
wherein
$${R}_{I , L , 1}^{-}$$
is the first vehicle negative isolation resistance,
$${R}_{I , S , 1}^{-}$$
is the first loaded negative isolation resistance,
$${R}_{I , S , e ,}^{-}$$
is the unloaded negative isolation resistance, V_{L,1} is the voltage of the first vehicle, V_{S} is the high-voltage of the electric charging station, and
$${R}_{I , L , 1}^{+}$$
is the first vehicle positive isolation resistance.

15. The electric charging station of claim 14, wherein to determine the second vehicle isolation resistance, the controller is further programmed to:
determine the second vehicle positive isolation resistance using an equation:
$${R}_{1 , L , 2}^{+} = {[ \frac{{V}_{S}}{{V}_{L , 2}} * [ \frac{1}{{R}_{I , S , 2}^{+}} - \frac{1}{{R}_{I , S , 1 ,}^{+}} ] ]}^{- 1}$$
wherein
$${R}_{I , L , 2}^{+}$$
is the second vehicle positive isolation resistance, Vₛ is a high-voltage of the electric charging station, V_{L,2} is a voltage of the second vehicle,
$${R}_{I , S , 2}^{+}$$
is the second loaded positive isolation resistance, and
$${R}_{I , S , 1}^{+}$$
is the first loaded positive isolation resistance; and
determine the second vehicle negative isolation resistance using an equation:
$${R}_{I , L , 2}^{-} = {[ \frac{1}{{R}_{I , S , 2}^{-}} - \frac{1}{{R}_{I , S , e}^{-}} - [ 1 - \frac{{V}_{L , 2}}{{V}_{S}} * \frac{1}{{R}_{I , L , 2}^{+}} ] ]}^{- 1}$$
wherein
$${R}_{I , L , 2}^{-}$$
is the second vehicle negative isolation resistance,
$${R}_{I , S , 2}^{-}$$
is the second loaded negative isolation resistance,
$${R}_{I , S , e ,}^{-}$$
is the unloaded negative isolation resistance, V_{L,2} is the voltage of the second vehicle, Vₛ is the high-voltage of the electric charging station, and
$${R}_{I , L , 2}^{+}$$
is the second vehicle positive isolation resistance.

16. The electric charging station of claim 15, wherein to change the operation of one or more of the plurality of contactors, the controller is further programmed to:
compare the second loaded isolation resistance to a predetermined isolation resistance threshold; and
disconnect one or more of the first vehicle and the second vehicle from the electric charging station using one or more of the plurality of contactors in response to determining that the second loaded isolation resistance is less than the predetermined isolation resistance threshold.

17. The electric charging station of claim 16, to disconnect one or more of the first vehicle and the second vehicle, the controller is further programmed to:
disconnect the first vehicle using one or more of the plurality of contactors in response to determining that the first vehicle positive isolation resistance is less than the second vehicle positive isolation resistance or that the first vehicle negative isolation resistance is less than the second vehicle negative isolation resistance; and
disconnect the second vehicle using one or more of the plurality of contactors in response to determining that the second vehicle positive isolation resistance is less than the first vehicle positive isolation resistance or that the second vehicle negative isolation resistance is less than the first vehicle negative isolation resistance.

18. A method for operating an electric charging station for charging a plurality of electric vehicles, the method comprising:
measuring an unloaded isolation resistance of the electric charging station with none of the plurality of electric vehicles connected, wherein the electric charging station includes a power source and a plurality of non-isolated converters for connecting each of the plurality of electric vehicles to the power source, and wherein the unloaded isolation resistance includes an unloaded positive isolation resistance and an unloaded negative isolation resistance;
measuring a loaded isolation resistance of the electric charging station with two or more of the plurality of electric vehicles connected to the electric charging station, wherein the two or more of the plurality of electric vehicles are in electrical communication with each other through the electric charging station; and
disconnecting one or more of the plurality of electric vehicles from the electric charging station based at least in part on at least one of: the unloaded isolation resistance and the loaded isolation resistance.

19. The method of claim 18, wherein measuring the loaded isolation resistance further comprises:
measuring a first loaded isolation resistance with a first vehicle of the plurality of electric vehicles connected to a first non-isolating converter of the plurality of non-isolated converters, wherein the first loaded isolation resistance includes a first loaded positive isolation resistance and a first loaded negative isolation resistance; and
measuring a second loaded isolation resistance with the first vehicle connected to the first non-isolating converter of the electric charging station and a second vehicle of the plurality of electric vehicles connected to a second non-isolating converter of the plurality of non-isolated converters, wherein the second loaded isolation resistance includes a second loaded positive isolation resistance and a second loaded negative isolation resistance.

20. The method of claim 19, wherein disconnecting one or more of the plurality of electric vehicles from the electric charging station further comprises:
determining a first vehicle isolation resistance based at least in part on the unloaded isolation resistance and the first loaded isolation resistance, wherein the first vehicle isolation resistance includes a first vehicle positive isolation resistance and a first vehicle negative isolation resistance;
determining a second vehicle isolation resistance based at least in part on the unloaded isolation resistance, the first loaded isolation resistance, and the second loaded isolation resistance, wherein the second vehicle isolation resistance includes a second vehicle positive isolation resistance and a second vehicle negative isolation resistance;
disconnecting the first vehicle in response to determining that the first vehicle positive isolation resistance is less than the second vehicle positive isolation resistance or that the first vehicle negative isolation resistance is less than the second vehicle negative isolation resistance; and
disconnecting the second vehicle in response to determining that the second vehicle positive isolation resistance is less than the first vehicle positive isolation resistance or that the second vehicle negative isolation resistance is less than the first vehicle negative isolation resistance.
